(19) United States
(12) Patent Application Publication
(10) Pub. No.: US 2026/0138033 A1
(43) Pub. Date: May 21, 2026

(54) SYSTEMS AND METHODS FOR MULTIPLAYER WORD GUESSING GAMEPLAY WITH ROOM-BASED SESSION MANAGEMENT AND DIFFICULTY-BASED HINT GENERATION

(71) Applicant: André Torongeau, Woodhaven, MI (US)

(72) Inventor: André Torongeau, Woodhaven, MI (US)

(21) Appl. No.: 19/393,790

(22) Filed: Nov. 19, 2025

Related U.S. Application Data
(60) Provisional application No. 63/696,195, filed on Sep. 18, 2024.

(51) Int. Cl. A63F 13/80; A63F 13/35; A63F 13/46; A63F 13/48; A63F 13/5375; A63F 13/798

(52) U.S. Cl. CPC A63F 13/80; A63F 13/35; A63F 13/46; A63F 13/48; A63F 13/5375; A63F 13/798

(57) ABSTRACT

A computer-implemented system for multiplayer word guessing gameplay includes a room management module configured to generate room identifiers and control session access. A word selection module enables host users to select target words and retrieves associated information from dictionary databases. A hint generation module provides hints based on selected difficulty levels, wherein beginner level provides three hints, novice level provides two hints, and expert level provides no hints. A scoring module calculates scores based on word characteristics, hint usage, and guess accuracy. A performance tracking module maintains records across game sessions and accumulates points over time. The system coordinates multiplayer sessions through room-based architecture, provides structured difficulty progression through integrated hint availability variation, and implements comprehensive scoring mechanisms that account for multiple gameplay factors while maintaining persistent performance records.

### CROSS-REFERENCE TO RELATED APPLICATIONS

The present application claims priority to U.S. Provisional Application No. 63/696,195 filed Sep. 18, 2024, titled “Word-Up Game App,” which is hereby incorporated by reference in its entirety.

### TECHNICAL FIELD

The embodiments generally relate to the technical field of computer-based multiplayer gaming systems for word guessing applications.

### BACKGROUND

Conventional word guessing games are designed to facilitate entertainment and vocabulary development through player interaction. Such games often operate as standalone applications on mobile devices or as web-based platforms accessible through browsers.

These games typically support basic word selection mechanisms and scoring systems. Many employ manual processes for organizing multiplayer sessions, requiring players to coordinate game setup through external communication channels such as text messages or social media platforms. Players must often manually track scores, manage turn sequences, and verify correct answers based on subjective evaluation or pre-programmed word lists.

Conventional solutions may also generate basic performance statistics or player rankings. These statistics are often limited to win-loss records or cumulative point totals. In many cases, gameplay difficulty within these systems is fixed or requires manual adjustment, with limited ability to adapt challenge levels based on player preferences or skill progression.

While such games provide entertainment value and vocabulary engagement, they face challenges in efficiently coordinating multiplayer sessions, maintaining consistent scoring mechanisms across different gameplay scenarios, or dynamically adjusting difficulty levels based on structured hint systems. Player coordination is often dependent on external communication tools disconnected from gameplay workflows, creating barriers to seamless game initiation. Additionally, hint systems in conventional games typically lack integration with difficulty progression, providing uniform assistance regardless of player experience level or game mode selection.

Consequently, there is a need for an improved word guessing game system that addresses the limitations of manual session coordination, provides enhanced scoring mechanisms that account for multiple gameplay factors, and offers structured difficulty progression through integrated hint systems.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, the disclosed system, method, or software product may include a room management module configured to generate room identifiers for game rooms and enable host users to invite other users to join multiplayer game sessions. The module may control access to game rooms based on room identifiers, ensuring that only authorized users participate in designated game sessions.

In one aspect, embodiments may include a word selection module configured to enable host users to select target words and provide information associated with target words to other users. The module may retrieve word-related information from dictionary databases or other data sources and communicate this information to participating users to facilitate gameplay.

In one aspect, embodiments may include a hint generation module configured to provide hints to assist users in guessing target words. The module may determine hint availability based on selected difficulty levels and may provide different types of hints including letter revelations or word usage examples to support varying gameplay experiences.

In one aspect, embodiments may include a scoring module configured to calculate scores based on multiple factors including characteristics of target words, numbers of hints utilized by users, and accuracy of submitted guesses. The module may apply scoring algorithms that account for word complexity, hint usage penalties, and successful guess rewards to generate comprehensive performance metrics.

In one aspect, embodiments may include a performance tracking module configured to maintain records of user performance across multiple game sessions. The module may accumulate points, track gameplay history, and generate performance statistics that enable users to monitor progress over time.

In one aspect, embodiments may include a user account module configured to authenticate users through various authentication mechanisms. The module may verify user credentials and manage user access to the game application platform.

In some aspects, the system may include at least one computing device in operable communication with a network and a server in operable communication with the network to host a game application platform containing the above-described modules. The computing device may execute instructions to perform the operations described herein, thereby enabling coordinated multiplayer word guessing gameplay with structured difficulty progression, integrated scoring mechanisms, and performance tracking capabilities.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 is a flow diagram illustrating an exemplary operational sequence of the User Account Module, according to some embodiments;

FIG. 4 is a flow diagram illustrating an exemplary operational sequence of the Room Management Module, according to some embodiments;

FIG. 5 is a flow diagram illustrating an exemplary operational sequence of the Word Selection Module, according to some embodiments;

FIG. 6 is a flow diagram illustrating an exemplary operational sequence of the Hint Generation Module, according to some embodiments;

FIG. 7 is a flow diagram illustrating an exemplary operational sequence of the Scoring Module, according to some embodiments;

FIG. 8 is a flow diagram illustrating an exemplary operational sequence of the Performance Tracking Module, according to some embodiments; and

FIG. 9 is a flow diagram illustrating an exemplary end-to-end system operational flow, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system may include at least one computing device in operable communication with a network and a server configured to host and execute a game application platform. The game application platform may include multiple functional modules, each implemented in software, firmware, hardware, or any combination thereof. In some embodiments, the modules may include a User Account Module configured to authenticate a plurality of users through various authentication mechanisms including manual credential entry or social media integration. A Room Management Module may generate room identifiers for game rooms, enable host users to invite other users to join game sessions, and control access to game rooms based on room identifier verification. A Word Selection Module may enable host users to select target words, query dictionary databases for information associated with target words, and provide retrieved information to users attempting to guess the target words. A Hint Generation Module may provide hints to assist users in guessing target words, wherein hint availability and hint types are determined based on selected difficulty levels. A Scoring Module may calculate scores based on multiple factors including characteristics of target words, numbers of hints utilized by users, and accuracy of submitted guesses. A Performance Tracking Module may maintain records of user performance across multiple game sessions, accumulate points over time, and generate historical performance statistics. A Communication and User Interface Module may provide user interfaces accessible via mobile devices or web browsers and enable users to interact with the game application platform. A Database Engine may manage structured game data storage and retrieval operations for the Data Repository.

Conventional word guessing game platforms often rely on manual coordination processes for organizing multiplayer sessions, with limited ability to streamline game setup or provide structured difficulty progression through integrated hint systems. The disclosed embodiments address this problem by combining room-based multiplayer coordination with automated hint generation, dynamic scoring calculations, and performance tracking to facilitate efficient gameplay experiences. This configuration enables coordinated multiplayer word guessing gameplay with difficulty-based hint availability, comprehensive scoring mechanisms that account for multiple gameplay factors, and persistent performance tracking across game sessions.

In practice and in use, the system may be deployed to facilitate multiplayer word guessing gameplay for entertainment and vocabulary engagement. When a user initiates a game session, the Room Management Module may generate a room identifier and enable the host user to invite other users via text message or email. The User Account Module may authenticate joining users and grant access to the game room based on room identifier verification. Once users have joined, the host user may select a target word through the Word Selection Module, which retrieves associated information from dictionary databases and provides this information to other users. Users attempting to guess the target word may request hints through the Hint Generation Module, which provides hints based on the selected difficulty level. When users submit guesses, the Scoring Module may evaluate guess accuracy and calculate scores based on word characteristics, hint usage, and spelling accuracy. The Performance Tracking Module may maintain cumulative records of user performance across multiple game sessions, enabling users to monitor progress over time.

In this way, the system may improve gameplay coordination by automating session setup processes, reducing reliance on external communication channels for multiplayer coordination, and providing structured gameplay through difficulty-based hint systems. The room-based architecture with unique identifiers eliminates manual coordination requirements and ensures that only authorized users participate in designated game sessions. The integrated hint generation functionality provides structured difficulty progression by varying hint availability and hint types based on selected difficulty levels. The comprehensive scoring mechanisms account for multiple gameplay factors including word complexity, hint usage penalties, and spelling accuracy rewards. The Performance Tracking Module preserves detailed gameplay records, as such, the system provides historical performance data that enables users to monitor skill progression and accumulated achievements. These capabilities can reduce setup latency by automating multiplayer coordination workflows, improve gameplay experiences by providing structured difficulty progression, and enhance user engagement through persistent performance tracking.

Various implementations of the present disclosure involve the technical field of computer-based multiplayer gaming systems for word guessing applications, including executing algorithms to generate room identifiers and control access to game sessions, querying dictionary databases to retrieve word-related information, applying rule-based logic to determine hint availability based on difficulty levels, calculating scores based on multiple gameplay factors, and maintaining persistent performance records across game sessions. These operations are inherently computer-based and cannot be performed in the human mind or using pen and paper due to the volume, speed, and complexity of the data being processed. For example, the system executes the steps of receiving game requests from multiple network-connected devices, generating unique room identifiers for session isolation, querying external dictionary databases for word definitions and characteristics, processing hint requests based on difficulty level configurations, evaluating submitted guesses for accuracy, calculating scores using multi-factor algorithms, and maintaining synchronized performance records across distributed user devices. The present disclosure amounts to more than merely implementing a generic computer as a tool to gather, analyze, and output data because the claimed operations improve the field of multiplayer gaming by enabling coordinated session management, structured difficulty progression through integrated hint systems, and comprehensive performance tracking rather than merely providing isolated word guessing functionality. In particular, the speed at which the steps of the present disclosure occur to effectuate the disclosed method, system, or product would involve real-time coordination of multiplayer sessions across network-connected devices, instantaneous retrieval of dictionary data from external databases, immediate evaluation of guess accuracy, and synchronized performance record updates across distributed systems. That is, the steps of the present method, system, or product are impossible to accomplish on pen and paper, cannot be accomplished as a method of organizing human activity, and amount to more than merely gathering, analyzing, and outputting data.

Various implementations of the present disclosure include executing computer-implemented coordination algorithms, dictionary query processing routines, and rule-based scoring engines on computing hardware to facilitate multiplayer word guessing gameplay. The computing system implements these algorithms when it performs tasks such as generating unique room identifiers for session isolation, verifying room access based on identifier matching, querying dictionary databases for word-related information, determining hint availability based on difficulty level configurations, evaluating submitted guesses for accuracy, calculating scores using multi-factor algorithms, and maintaining synchronized performance records. In particular, the speed at which the system coordinates multiplayer sessions across network-connected devices, retrieves dictionary data from external sources, processes hint requests based on difficulty configurations, evaluates guess submissions, and updates performance records would involve continuous, high-frequency data processing across networked systems. As such, the present disclosure would be impossible to accomplish on pen and paper or in the human mind due to the volume of real-time coordination data being processed, the number of simultaneous gameplay operations being performed, and the speed required to provide seamless multiplayer experiences.

In some embodiments, the Room Management Module processes game session requests by generating unique room identifiers, enabling host users to configure game parameters and invite other users, verifying room access based on identifier matching, and coordinating session initiation when users have joined. The Word Selection Module executes dictionary queries to retrieve word-related information, extracts definitions and characteristics from query results, and communicates this information to users participating in game sessions. The Hint Generation Module applies rule-based logic to determine hint availability based on difficulty level configurations, generates appropriate hints based on target word characteristics, and logs hint usage for scoring calculations. The Scoring Module applies multi-factor algorithms that integrate word characteristics, hint usage data, and guess accuracy evaluations to calculate comprehensive scores. The foregoing operations are executed as sequences of database queries, algorithmic calculations, conditional logic evaluations, and network communications across distributed systems, and cannot practically be performed in the human mind or on paper. These concrete processing steps of room-based session coordination, dictionary data integration, difficulty-based hint generation, and multi-factor scoring provide a specific improvement to multiplayer word guessing game systems by enabling structured gameplay coordination with persistent performance tracking, rather than a mere abstract idea of organizing human activity.

The disclosed game application platform incorporates several technical features that distinguish it from conventional word guessing game systems. In some embodiments, the platform may implement room-based session management that generates unique room identifiers to isolate game sessions and control participant access. Each generated room identifier may enable the host user to coordinate multiplayer sessions without requiring external communication tools to manage participation. The Room Management Module may verify room identifiers when users attempt to join sessions, ensuring that only authorized users with correct identifiers can access designated game rooms.

In some embodiments, the platform may implement difficulty-based hint availability that varies the number and types of hints provided based on selected difficulty levels. Unlike conventional systems that provide uniform hint availability regardless of player experience or game mode, the disclosed platform may dynamically determine hint availability by evaluating difficulty level configurations. When users select beginner difficulty levels, the Hint Generation Module may provide three hints including first letter revelation, initial letters revelation, and word usage examples. When users select novice difficulty levels, the module may provide two hints. When users select expert difficulty levels, the module may provide no hints, requiring users to guess target words based solely on provided definitions. This difficulty-based hint availability ensures that gameplay challenge scales appropriately based on player preferences and skill levels.

In some embodiments, the platform may implement multi-factor scoring algorithms that calculate scores based on integrated evaluation of word characteristics, hint usage, and guess accuracy. The Scoring Module may calculate base scores based on characteristics of target words such as word length or number of available definitions, apply penalty deductions based on numbers of hints utilized by users, and award bonus points for correct spelling when guesses are accurate. The scoring algorithms may integrate these multiple factors to generate comprehensive scores that reflect both word complexity and player performance. When users utilize hints during gameplay, the Scoring Module may deduct progressively larger point values for each hint utilized, wherein first hints deduct smaller values, second hints deduct larger values, and third hints deduct the largest values. This progressive penalty structure incentivizes users to minimize hint usage while still providing assistance when needed.

In some embodiments, the platform may implement persistent performance tracking that maintains cumulative records of user performance across multiple game sessions. The Performance Tracking Module may receive score data from the Scoring Module after each game round, accumulate points across sessions, update user performance statistics, and generate historical performance displays. Unlike conventional systems that track only current session statistics, the disclosed platform may maintain long-term performance records that enable users to monitor skill progression and accumulated achievements over time. The maintained records may include cumulative point totals, numbers of games played, average scores per session, and historical trends in performance metrics.

In some embodiments, the platform may implement invitation-based session coordination that enables host users to invite other users via text message or email without requiring external coordination tools. The Room Management Module may generate invitation messages containing room identifiers and transmit these messages to specified recipients through communication channels. This integrated invitation functionality eliminates the need for users to coordinate game sessions through separate messaging applications or social media platforms, streamlining the process of organizing multiplayer gameplay.

In some embodiments, the platform may incorporate dictionary database integration that retrieves word-related information from external data sources in real-time during gameplay. The Word Selection Module may interface with dictionary databases or application programming interfaces to query for definitions, word characteristics, and usage examples associated with target words selected by host users. By establishing connections with external dictionary resources, the platform may access comprehensive word data without requiring local storage of extensive dictionary datasets, enabling deployment across resource-constrained devices while maintaining access to broad vocabulary coverage.

These technical features may collectively transform word guessing gameplay from isolated single-player or manually coordinated multiplayer experiences into structured, coordinated multiplayer sessions with difficulty progression and performance tracking. Whereas conventional systems may require manual coordination through external tools and provide limited difficulty scaling, the disclosed platform may coordinate multiplayer sessions through room-based architecture, provide structured difficulty progression through hint availability variation, and maintain persistent performance records. By integrating room management, dictionary data retrieval, hint generation, scoring calculations, and performance tracking into a unified game platform, the system may address fundamental limitations in current word guessing game approaches that separate session coordination from gameplay mechanics.

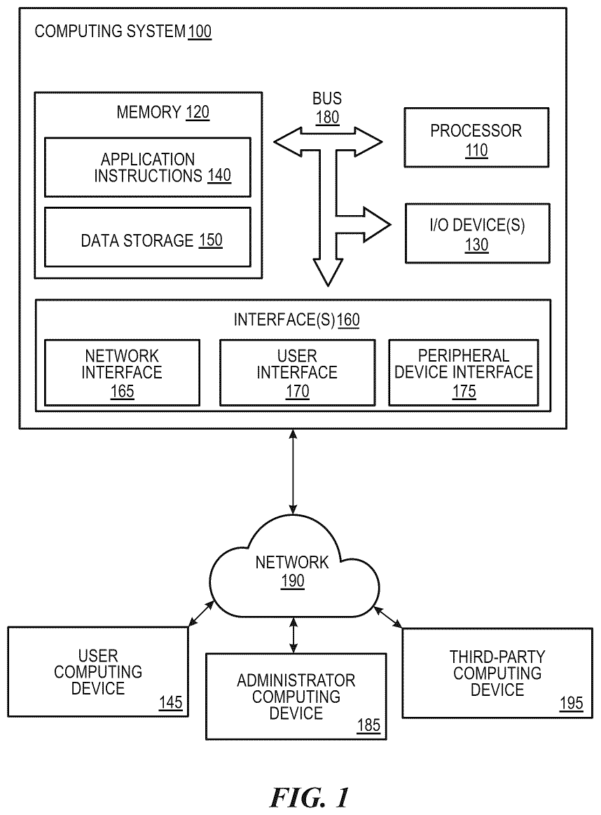

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 enables the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

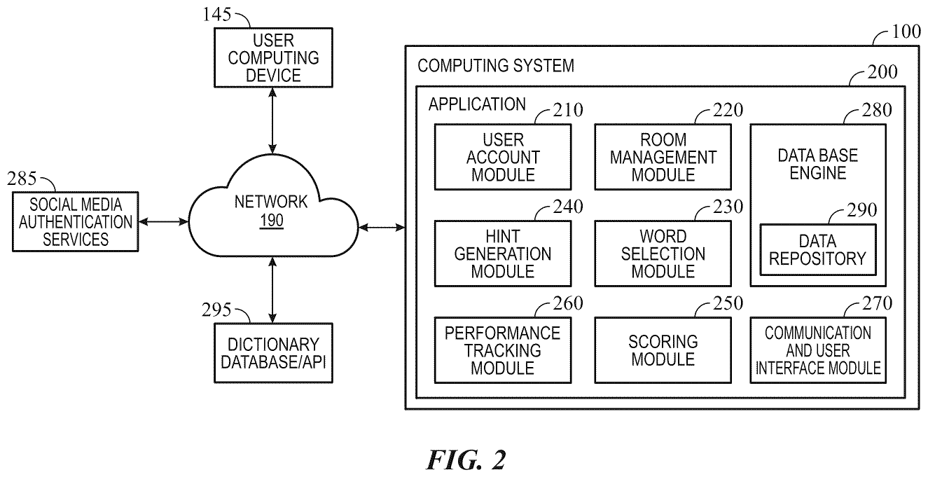

FIG. 2 illustrates an example computer architecture for the application program 200 operated via the computing system 100. The computing system 100 comprises several modules and engines configured to execute the functionalities of the application program 200, and a database engine 280 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a User Account Module 210, a Room Management Module 220, a Word Selection Module 230, a Hint Generation Module 240, a Scoring Module 250, a Performance Tracking Module 260, and a Communication and User Interface Module 270. The application program 200 further interfaces with a Database Engine 280 that manages operations for the Data Repository 290. The computing system 100 communicates via network 190 with external systems including user computing devices 145, social media authentication services 285, and dictionary database or application programming interface (API) 295.

In some embodiments, the User Account Module 210 may be configured to authenticate a plurality of users through various authentication mechanisms. The User Account Module 210 may receive authentication requests from users via the Communication and User Interface Module 270 and determine which authentication method to apply based on user preferences or system configuration. In some embodiments, the User Account Module 210 may authenticate users through manual credential entry by prompting users to provide username and password combinations, validating these credentials against stored user account data in the Data Repository 290, and granting access when credentials match stored records. The User Account Module 210 may alternatively authenticate users through social media integration by establishing connections with social media authentication services 285 via the Network 190, transmitting authentication tokens or user identifiers to these external services, receiving verification responses confirming user identity, and granting access based on successful social media authentication.

In some embodiments, the User Account Module 210 may create new user accounts when authentication requests come from users who do not have existing accounts in the system. The module may generate new user records containing user identifiers, authentication credentials, account creation timestamps, and initial performance statistics. The User Account Module 210 may store these new user records in the Data Repository 290 via the Database Engine 280. In some embodiments, the User Account Module 210 may implement session management functionality that maintains user authentication state throughout gameplay sessions, enabling authenticated users to access game features without repeated credential verification. This authentication functionality ensures that only verified users access the game application platform 200 and enables the system to associate gameplay activities with specific user accounts for performance tracking purposes.

In some embodiments, the Room Management Module 220 may be configured to coordinate multiplayer game sessions by generating room identifiers and controlling access to game rooms. The Room Management Module 220 may receive room creation requests from host users via the Communication and User Interface Module 270 when users initiate new game sessions. In some embodiments, the Room Management Module 220 may generate a room identifier for a game room by executing identifier generation algorithms that produce unique alphanumeric codes or numeric sequences that distinguish the game room from other concurrent game sessions. The generated room identifier serves as an access control mechanism that enables the host user to invite at least one other user to join the game room while preventing unauthorized users from accessing the session.

The Room Management Module 220 may enable the host user to configure game parameters before other users join the game room. In some embodiments, the module may receive configuration inputs specifying a selected difficulty level comprising at least one of a beginner level, a novice level, or an expert level. The Room Management Module 220 may also enable the host user to select a number of rounds to be played in the game room, wherein each round comprises selection and guessing of a different target word. The module may store these configuration parameters in association with the room identifier in the Data Repository 290.

In some embodiments, the Room Management Module 220 may enable the host user to invite the at least one other user via at least one of text message or email by generating invitation messages containing the room identifier and transmitting these messages through communication channels. The module may interface with messaging services or email servers via the Network 190 to deliver invitation messages to recipient devices. When other users receive invitation messages, they may use the room identifier to submit join requests to the Room Management Module 220.

The Room Management Module 220 may receive join requests containing room identifiers from users attempting to access game rooms. In some embodiments, the module may verify submitted room identifiers by comparing received identifiers to identifiers of active game rooms stored in the Data Repository 290. The Room Management Module 220 may determine room availability by evaluating whether the game room associated with the verified room identifier is accepting new participants or has reached capacity limits. When room identifier verification succeeds and the room is available, the Room Management Module 220 may grant access to the game room by associating the joining user with the room session and enabling the user to participate in gameplay. When verification fails or the room is unavailable, the module may deny access and generate notification messages explaining why access was denied.

In some embodiments, the Room Management Module 220 may enable the at least one other user to rejoin the game room using the room identifier if the user's connection is interrupted during gameplay. The module may maintain session state information that enables reconnection without requiring complete re-authentication or loss of gameplay progress. This room-based architecture eliminates the need for users to coordinate multiplayer sessions through external communication platforms and ensures that only users possessing correct room identifiers can access designated game sessions.

In some embodiments, the Word Selection Module 230 may be configured to enable the host user to select a target word and to provide information associated with the target word to the at least one other user. The Word Selection Module 230 may generate word selection interfaces that display vocabulary options or enable the host user to input custom words. In some embodiments, the module may receive word selection inputs from the host user via the Communication and User Interface Module 270, wherein the received inputs specify which target word the host user has chosen for the current game round.

The Word Selection Module 230 may query dictionary database or API 295 via the Network 190 to retrieve information associated with the selected target word. In some embodiments, the module may generate database queries or API requests containing the target word as a search parameter and transmit these queries to external dictionary resources. The dictionary database or API 295 may process the received queries and return word-related data including definitions, word characteristics, usage examples, and linguistic properties. The Word Selection Module 230 may receive these query responses and parse the returned data to extract relevant information.

In some embodiments, the information associated with the target word may comprise at least one definition of the target word retrieved from the dictionary database or API 295. When the external dictionary resource returns multiple definitions for polysemous words, the Word Selection Module 230 may extract all available definitions and determine how many definitions to provide to users attempting to guess the target word. The module may provide information associated with the target word to the at least one other user by transmitting the extracted definitions and word characteristics to the Communication and User Interface Module 270 for display on user computing devices 145.

The Word Selection Module 230 may also extract characteristics of the target word for use by other modules in the application program 200. In some embodiments, the characteristics may include a number of letters in the target word, which the Scoring Module 250 uses to calculate scores. The module may store the selected target word and associated information in the Data Repository 290 via the Database Engine 280 for the duration of the current game round. This stored information remains accessible to other modules that require target word data during gameplay operations, such as the Hint Generation Module 240 for generating hints and the Scoring Module 250 for evaluating submitted guesses.

In some embodiments, the Hint Generation Module 240 may be configured to provide at least one hint to assist the at least one other user in guessing the target word. The Hint Generation Module 240 may receive hint requests from users via the Communication and User Interface Module 270 when users attempting to guess the target word seek assistance. In some embodiments, the module may determine availability of the at least one hint based on a selected difficulty level by retrieving the difficulty level configuration stored by the Room Management Module 220 and evaluating hint availability rules associated with that difficulty level.

The Hint Generation Module 240 may apply different hint availability rules depending on the selected difficulty level. In some embodiments, when the selected difficulty level comprises a beginner level, the module may provide three hints. When the selected difficulty level comprises a novice level, the module may provide two hints. When the selected difficulty level comprises an expert level, the module may provide no hints, requiring users to guess the target word based solely on the information provided by the Word Selection Module 230. This difficulty-based hint availability creates structured gameplay progression that scales challenge level based on user preferences.

In some embodiments, the at least one hint may comprise a first hint revealing a first letter of the target word, a second hint revealing a plurality of initial letters of the target word, and a third hint providing an example using the target word. The Hint Generation Module 240 may generate these hints by retrieving the target word from the Data Repository 290 and extracting the appropriate components. For the first hint, the module may extract the character at the initial position of the target word string. For the second hint, the module may extract the first three characters of the target word, though this hint may not be provided if the target word contains three letters or fewer. For the third hint, the module may retrieve usage examples from the dictionary data previously obtained by the Word Selection Module 230 or may generate contextual examples demonstrating how the target word is used in sentences.

The Hint Generation Module 240 may track hint usage by maintaining counters that record how many hints each user has utilized during the current game round. In some embodiments, the module may increment these counters each time a hint is provided and may store the updated hint usage counts in the Data Repository 290. The module may transmit hint usage data to the Scoring Module 250 to enable point deductions based on the number of hints utilized by users. In some embodiments, the Hint Generation Module 240 may prevent users from requesting additional hints after they have exhausted the available hints for the selected difficulty level by comparing current hint usage counts to maximum hint availability for that difficulty level.

In some embodiments, the Scoring Module 250 may be configured to calculate a score based on at least one of: a characteristic of the target word, a number of hints utilized by a user, or accuracy of a guess submitted by the user. The Scoring Module 250 may receive guess submissions from users via the Communication and User Interface Module 270 when users attempt to identify the target word. In some embodiments, the module may evaluate guess accuracy by comparing the submitted guess to the target word stored in the Data Repository 290, determining whether the submitted guess matches the target word exactly or within acceptable similarity thresholds.

The Scoring Module 250 may calculate scores using multi-factor algorithms that integrate multiple gameplay variables. In some embodiments, the characteristic of the target word may comprise a number of letters in the target word, and the Scoring Module 250 may award points based on this letter count. The module may retrieve the target word from the Data Repository 290, determine the length of the word by counting characters, and use this length value as a base score component. Words with more letters may generate higher base scores than words with fewer letters, reflecting increased difficulty in guessing longer words.

In some embodiments, when the information associated with the target word comprises a plurality of definitions, the Scoring Module 250 may base the score on a number of definitions. The module may retrieve definition count data from the Word Selection Module 230 or the Data Repository 290 and incorporate this count into score calculations. Words with multiple definitions may generate higher scores than words with single definitions, reflecting greater complexity in word meaning.

The Scoring Module 250 may apply penalty deductions based on hint usage. In some embodiments, the module may retrieve hint usage data from the Hint Generation Module 240 indicating how many hints the user utilized during the current round. The Scoring Module 250 may deduct points from calculated scores based on this hint usage data. In some embodiments, the module may deduct a first point value when a first hint is utilized, deduct a second point value when a second hint is utilized, and deduct a third point value when a third hint is utilized, wherein the second point value is greater than the first point value and the third point value is greater than the second point value. This progressive penalty structure incentivizes users to minimize hint usage while still providing assistance when needed.

In some embodiments, the Scoring Module 250 may award additional points for correct spelling when the submitted guess matches the target word exactly. The module may compare the submitted guess character-by-character to the target word to verify spelling accuracy, and may add bonus points to the calculated score when spelling is correct. The final calculated score reflects the integration of word characteristics, definition counts, hint usage penalties, and spelling accuracy bonuses.

The Scoring Module 250 may transmit calculated scores to users via the Communication and User Interface Module 270 for display on user computing devices 145. In some embodiments, the module may also transmit score data to the Performance Tracking Module 260 to enable cumulative point accumulation across multiple game sessions. The comprehensive scoring mechanisms implemented by the Scoring Module 250 account for multiple gameplay factors and provide quantitative feedback on user performance that reflects both word complexity and player skill.

In some embodiments, the Performance Tracking Module 260 may be configured to maintain a record of user performance across a plurality of game sessions. The Performance Tracking Module 260 may receive score data from the Scoring Module 250 after each game round and store this data in association with user accounts in the Data Repository 290 via the Database Engine 280. In some embodiments, the module may accumulate points across the plurality of game sessions by maintaining cumulative point totals for each user account. When new score data is received, the module may retrieve the user's existing cumulative point total from the Data Repository 290, add the new score to this total, and store the updated cumulative total back to the repository.

The Performance Tracking Module 260 may generate performance statistics that summarize user gameplay history. In some embodiments, the module may calculate metrics such as total games played, average score per session, highest score achieved, most frequently used difficulty levels, and average hint usage rates. The module may analyze historical performance data to identify trends in user skill progression over time. In some embodiments, the Performance Tracking Module 260 may display historical performance data to at least one of the plurality of users by generating performance summary interfaces that visualize accumulated points, gameplay statistics, and achievement milestones.

The Performance Tracking Module 260 enables users to monitor progress and skill development across extended periods of gameplay. In some embodiments, the module may implement achievement systems that recognize when users reach point thresholds or complete gameplay objectives. The persistent performance records maintained by the Performance Tracking Module 260 provide continuity across game sessions and enable long-term engagement tracking that would not be possible with session-isolated scoring systems.

In some embodiments, the Communication and User Interface Module 270 may be configured to facilitate interactions between users and the game application platform 200. The Communication and User Interface Module 270 may generate user interfaces that are transmitted to user computing devices 145 via the Network 190 for display on device screens. In some embodiments, the generated interfaces may display game room information including assigned room identifiers, lists of participating users, configured game parameters, and current game round status.

The Communication and User Interface Module 270 may enable users to submit various types of inputs to the application program 200. In some embodiments, the module may receive authentication requests for processing by the User Account Module 210, room creation requests for processing by the Room Management Module 220, word selection inputs for processing by the Word Selection Module 230, hint requests for processing by the Hint Generation Module 240, and guess submissions for processing by the Scoring Module 250. The module routes these received inputs to appropriate modules within the application program 200 for processing.

In some embodiments, the Communication and User Interface Module 270 may display information generated by other modules to users. The module may display information associated with target words retrieved by the Word Selection Module 230, hints generated by the Hint Generation Module 240, calculated scores produced by the Scoring Module 250, and performance statistics generated by the Performance Tracking Module 260. In some embodiments, the module may support access from mobile devices such as smartphones and tablets, enabling users to participate in gameplay from various device types without requiring fixed workstations. The Communication and User Interface Module 270 may implement authentication mechanisms to verify user identity before granting access to game features and may enforce access controls that restrict which functions users can access based on their role in game sessions, such as host user versus joining user.

In some embodiments, the Database Engine 280 may be configured to manage data storage and retrieval operations for the Data Repository 290. The Database Engine 280 may execute database queries submitted by other components of the application program 200, maintain indexes that enable efficient data retrieval, and ensure data integrity by enforcing constraints on stored data. In some embodiments, the Database Engine 280 may manage storage of user account records, room configuration data, target word information, hint usage records, calculated scores, and performance statistics in the Data Repository 290.

The Database Engine 280 may support concurrent access by multiple modules, enabling the User Account Module 210, Room Management Module 220, Word Selection Module 230, Hint Generation Module 240, Scoring Module 250, and Performance Tracking Module 260 to read and write data simultaneously without conflicts. In some embodiments, the Database Engine 280 may implement transaction management mechanisms that ensure data consistency when multiple modules attempt to modify related data simultaneously. The Database Engine 280 may also implement data backup and recovery mechanisms that protect stored game data from loss due to system failures.

In some embodiments, the Data Repository 290 may store structured game data used by the application program 200. The Data Repository 290 may contain user account records including user identifiers, authentication credentials, account creation timestamps, and user preferences. The Data Repository 290 may contain room configuration records including room identifiers, host user identifiers, selected difficulty levels, configured round counts, and lists of participating users. The Data Repository 290 may contain gameplay records including selected target words, retrieved definitions and characteristics, hint usage counters, submitted guesses, calculated scores, and performance statistics.

In some embodiments, the Data Repository 290 may store word libraries containing vocabulary sets from which host users can select target words, though in other embodiments target word selection may rely entirely on external dictionary database or API 295. The Data Repository 290 may store historical performance data spanning multiple game sessions for each user account, enabling the Performance Tracking Module 260 to generate long-term performance analytics. In some embodiments, the Data Repository 290 may be implemented as a relational database, a document-oriented database, or a distributed storage system depending on system requirements and anticipated data volumes.

In some embodiments, the Network 190 may be a public or private data network, such as the Internet or a corporate intranet, enabling communication between the computing system 100, user computing devices 145, social media authentication services 285, and dictionary database or API 295. The Network 190 may utilize standard communication protocols such as Transmission Control Protocol/Internet Protocol (TCP/IP), Hypertext Transfer Protocol Secure (HTTPS), or other network protocols to facilitate data transmission between connected systems. In some embodiments, the Network 190 may support both wired and wireless connections, enabling user computing devices 145 to access the game application platform 200 from various locations and connection types. The Network 190 may implement security measures such as encryption protocols to protect user credentials and gameplay data during transmission between the computing system 100 and user computing devices 145.

User computing devices 145 may be mobile devices such as smartphones or tablets, portable computing devices such as laptops, or fixed workstations such as desktop computers. In some embodiments, user computing devices 145 may execute web browsers or dedicated mobile applications that interface with the Communication and User Interface Module 270 to display game interfaces, room information, target word definitions, hints, and calculated scores. Users may interact with user computing devices 145 to submit authentication credentials, create game rooms, join existing rooms, select target words when serving as host users, request hints, and submit guesses. The user computing devices 145 may communicate with the computing system 100 via the Network 190 using encrypted connections to maintain data security during transmission of user inputs and game data.

In some embodiments, social media authentication services 285 may be external authentication platforms operated by social media companies that maintain user identity verification systems. The social media authentication services 285 may include platforms such as Facebook Login, Google Sign-In, Apple ID authentication, or other third-party identity providers. The User Account Module 210 may establish connections with social media authentication services 285 via the Network 190 using standardized authentication protocols such as OAuth or OpenID Connect. When users select social media authentication options, the User Account Module 210 may redirect users to authentication interfaces provided by social media authentication services 285, receive authentication tokens confirming successful identity verification, and grant access to the game application platform 200 based on these tokens. This integration enables users to access the game application platform 200 without creating separate account credentials, streamlining the authentication process and reducing barriers to user participation.

Dictionary database or API 295 may be external data sources that provide word definitions, linguistic information, and vocabulary data. In some embodiments, the dictionary database or API 295 may be commercially available dictionary services, open-source lexical databases, or custom vocabulary repositories. The Word Selection Module 230 may query dictionary database or API 295 via the Network 190 using API requests or database queries to retrieve information associated with target words selected by host users. In some embodiments, the dictionary database or API 295 may return comprehensive word data including multiple definitions for polysemous words, part-of-speech classifications, pronunciation guides, etymology information, and usage examples.

The integration between the Word Selection Module 230 and dictionary database or API 295 enables the game application platform 200 to access extensive vocabulary coverage without requiring local storage of complete dictionary datasets. This external data sourcing reduces storage requirements on the computing system 100 and enables deployment across resource-constrained devices while maintaining access to comprehensive word information. In some embodiments, the dictionary database or API 295 may update its vocabulary datasets independently of the game application platform 200, ensuring that users have access to current linguistic information including newly coined words and evolving definitions without requiring updates to the application program 200.

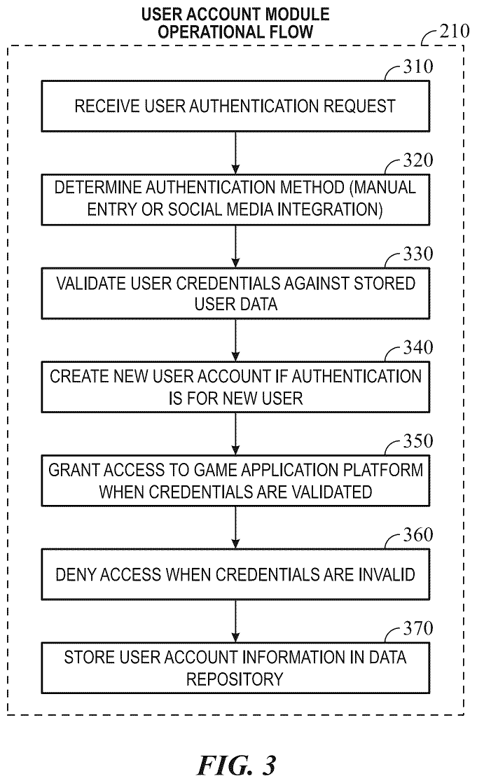

FIG. 3 is a flow diagram illustrating an exemplary operational sequence of the User Account Module 210 in accordance with certain embodiments. The sequence shown may be implemented as computer-executable instructions within the application program 200 operating on computing system 100 of FIG. 2, with specific operations performed by the modules depicted therein.

At step 310, a user authentication request is received from a user. This operation may be performed by the User Account Module 210 in coordination with the Communication and User Interface Module 270 of FIG. 2. In some embodiments, users may submit authentication requests through user interfaces displayed on user computing devices 145 by selecting authentication options, entering credential information, or initiating social media authentication flows. The Communication and User Interface Module 270 may receive the submitted authentication request via the Network 190, extract authentication parameters such as authentication method selection, username inputs, password inputs, or social media authentication tokens, and forward the extracted parameters to the User Account Module 210 for processing. In some embodiments, the authentication request may include device identifiers or session tokens that enable the User Account Module 210 to associate authentication attempts with specific user devices or browser sessions.

At step 320, the authentication method is determined. This operation is performed by the User Account Module 210, which evaluates the authentication request received in step 310 to identify which authentication mechanism the user has selected. In some embodiments, the User Account Module 210 may determine whether the user has selected manual entry authentication or social media integration authentication by analyzing authentication parameters included in the received request. When the authentication request includes username and password combinations, the User Account Module 210 may determine that manual entry authentication should be applied. When the authentication request includes social media authentication tokens or redirect parameters from social media authentication services 285, the User Account Module 210 may determine that social media integration authentication should be applied. In some embodiments, the User Account Module 210 may apply default authentication methods when authentication requests do not specify particular authentication mechanisms, such as defaulting to manual entry authentication for initial authentication attempts.

At step 330, user credentials are validated against stored user data. This operation is performed by the User Account Module 210, which executes validation processes appropriate to the authentication method determined in step 320. In some embodiments, when manual entry authentication has been selected, the User Account Module 210 may retrieve the username provided in the authentication request and query the Data Repository 290 via the Database Engine 280 to locate user account records matching the provided username. The User Account Module 210 may extract stored password hashes or encrypted password values from the retrieved user account records and compare these stored credentials to the password provided in the authentication request. The comparison may involve applying cryptographic hash functions to the provided password and comparing the resulting hash value to the stored hash value to determine whether credentials match. When the comparison indicates that provided credentials match stored credentials, the validation succeeds. When the comparison indicates that credentials do not match or when no user account record is found for the provided username, the validation fails.

In some embodiments, when social media integration authentication has been selected, the User Account Module 210 may transmit authentication tokens received in the authentication request to social media authentication services 285 via the Network 190. The social media authentication services 285 may verify the authenticity of the received tokens and return verification responses indicating whether the tokens are valid and which user identity the tokens represent. The User Account Module 210 may receive these verification responses and determine whether credentials are validated based on the success or failure indicators included in the responses. In some embodiments, the User Account Module 210 may query the Data Repository 290 to determine whether user accounts already exist for the social media identities confirmed by social media authentication services 285, enabling the module to distinguish between returning users and new users accessing the system through social media authentication.

At step 340, a new user account is created if authentication is for a new user. This operation is performed by the User Account Module 210 when the validation process in step 330 determines that no existing user account matches the provided credentials or social media identity. In some embodiments, the User Account Module 210 may generate new user account records containing user identifiers, authentication credentials, account creation timestamps, and initial configuration parameters. When creating accounts for manual entry authentication, the User Account Module 210 may store the provided username and a cryptographically hashed version of the provided password in the new user account record. When creating accounts for social media authentication, the module may store social media platform identifiers and user identity tokens received from social media authentication services 285.

The User Account Module 210 may generate unique user identifiers for new accounts by executing identifier generation algorithms that produce alphanumeric codes or sequential numeric values that distinguish each user account from other accounts in the system. In some embodiments, the module may initialize performance tracking records for new user accounts by creating empty performance history entries in the Data Repository 290 that will be populated by the Performance Tracking Module 260 as the user participates in gameplay. The User Account Module 210 may also establish default preferences for new accounts, such as default difficulty level selections or notification settings, which users can modify through configuration interfaces after account creation.

At step 350, access to the game application platform is granted when credentials are validated. This operation is performed by the User Account Module 210 when the validation process in step 330 successfully confirms that provided credentials match stored user data or when social media authentication services 285 verify authentication tokens. In some embodiments, the User Account Module 210 may generate session tokens or authentication cookies that maintain user authentication state throughout gameplay sessions. The module may transmit these session tokens to user computing devices 145 via the Communication and User Interface Module 270 and the Network 190, enabling the devices to include the tokens in subsequent requests to the game application platform 200 without requiring repeated credential entry.

The User Account Module 210 may retrieve user account data from the Data Repository 290 and transmit this data to the Communication and User Interface Module 270 for presentation to the authenticated user. In some embodiments, the transmitted account data may include user identifiers, account preferences, accumulated performance statistics, and available game features. The Communication and User Interface Module 270 may use this data to generate personalized user interfaces that display user-specific information and enable access to game features. In some embodiments, granting access may involve updating last login timestamps in user account records, recording successful authentication events in audit logs, or incrementing login counter statistics maintained by the system.

At step 360, access is denied when credentials are invalid. This operation is performed by the User Account Module 210 when the validation process in step 330 determines that provided credentials do not match stored user data or when social media authentication services 285 return verification failure responses. In some embodiments, the User Account Module 210 may generate error messages or denial notifications that explain why authentication failed, such as indicating that the username does not exist, that the password is incorrect, or that social media authentication could not be completed. The module may transmit these denial notifications to user computing devices 145 via the Communication and User Interface Module 270 for display to users.

In some embodiments, the User Account Module 210 may implement security measures that respond to repeated authentication failures. The module may track failed authentication attempts by maintaining counters associated with usernames or device identifiers, incrementing these counters each time validation fails, and comparing counter values to predetermined thresholds. When failed attempt counts exceed thresholds, the User Account Module 210 may temporarily block authentication attempts from the associated username or device identifier by rejecting authentication requests without performing validation processes. This temporary blocking prevents brute force attacks where malicious actors attempt to guess passwords through repeated authentication attempts. In some embodiments, the User Account Module 210 may implement progressive delay mechanisms that increase the time required between authentication attempts as failed attempt counts grow, slowing automated attack attempts without completely blocking legitimate users who may have forgotten credentials.

At step 370, user account information is stored in the data repository. This operation is performed by the User Account Module 210 in coordination with the Database Engine 280. In some embodiments, the User Account Module 210 may store user account information created in step 340 when new accounts are generated for previously unknown users. The module may transmit database insertion commands to the Database Engine 280 containing new user account records, and the Database Engine 280 may execute these commands to persist the records in the Data Repository 290. The stored user account information includes authentication credentials, user identifiers, account creation timestamps, and any configuration parameters established during account creation.

In some embodiments, the User Account Module 210 may also update existing user account records when authenticated users modify account settings or when system events require updates to stored data. The module may transmit database update commands to the Database Engine 280 specifying which user account records to modify and what new values to store. In some embodiments, stored user account information may include authentication history logs that record timestamps of successful and failed authentication attempts, enabling security auditing and user activity tracking. The User Account Module 210 may store preference settings that users configure through account management interfaces, such as notification preferences, default difficulty level selections, or display customization options. This stored information persists across authentication sessions and enables the system to maintain consistent user experiences when users authenticate at different times or from different devices.

In some embodiments, the operations of steps 310 through 370 occur automatically each time a user attempts to access the game application platform 200. The automated execution of these authentication steps ensures that only verified users can access game features and that each user's gameplay activities are associated with their specific user account for performance tracking purposes. In some embodiments, the User Account Module 210 may cache authentication results temporarily to reduce database query overhead when users perform multiple actions in rapid succession during gameplay sessions, while still maintaining security by expiring cached authentication data after predetermined time periods.

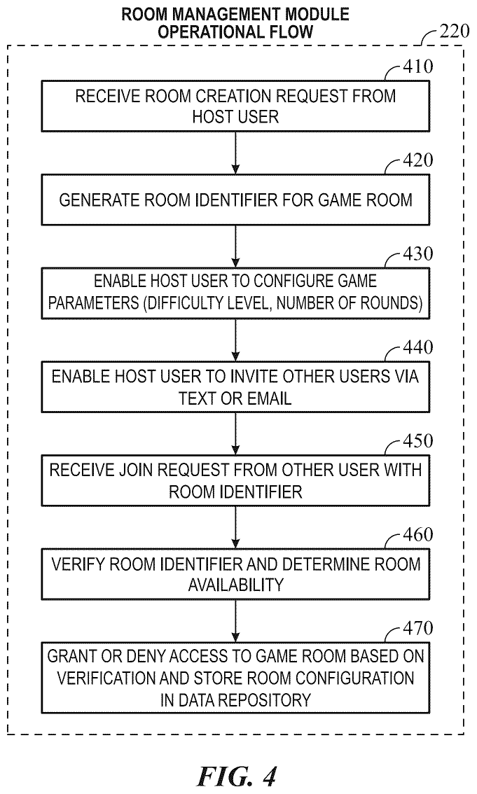

FIG. 4 is a flow diagram illustrating an exemplary operational sequence of the Room Management Module 220 in accordance with certain embodiments. The sequence shown may be implemented as computer-executable instructions within the application program 200 operating on computing system 100 of FIG. 2, with specific operations performed by the modules depicted therein.

At step 410, a room creation request is received from a host user. This operation may be performed by the Room Management Module 220 when authenticated users initiate new game sessions. In some embodiments, the host user may submit room creation requests through user interfaces provided by the Communication and User Interface Module 270, wherein the requests signal the user's intent to establish a new multiplayer game session. The Room Management Module 220 may receive these requests along with user identifiers that designate which authenticated user is initiating the session, enabling the module to associate the created game room with the host user's account.

At step 420, a room identifier is generated for the game room. This operation is performed by the Room Management Module 220, which executes identifier generation algorithms to produce the room identifier. In some embodiments, the Room Management Module 220 may generate the room identifier by combining random number generation with timestamp values to ensure uniqueness across concurrent game sessions. The module may execute cryptographic random number generators that produce alphanumeric strings of predetermined lengths, such as six-character codes or eight-digit numeric sequences. In some embodiments, the Room Management Module 220 may verify that generated identifiers are not currently assigned to other active game rooms by querying the Data Repository 290 to check for identifier collisions, and may regenerate new identifiers when collisions are detected. The generated room identifier serves as the access control mechanism that enables the host user to control which users can participate in the game session.

At step 430, the host user is enabled to configure game parameters. This operation is performed by the Room Management Module 220, which presents configuration interfaces through the Communication and User Interface Module 270 and receives configuration inputs from the host user. In some embodiments, the configuration parameters may include the selected difficulty level, wherein the host user specifies whether the game session will operate at a beginner level, novice level, or expert level. The Room Management Module 220 may receive difficulty level selections and associate these selections with the generated room identifier in the Data Repository 290. In some embodiments, the host user may also configure the number of rounds to be played in the game room, wherein each round comprises a distinct target word selection and guessing cycle. The Room Management Module 220 may receive round count specifications and store these values in association with the room identifier, enabling the system to track game session progress and determine when configured rounds have been completed.

At step 440, the host user is enabled to invite other users via text or email. This operation is performed by the Room Management Module 220, which generates invitation messages and coordinates transmission through external communication channels. In some embodiments, the Room Management Module 220 may generate invitation message content that includes the room identifier, instructions for joining the game room, and optional personalized messages composed by the host user. When the host user selects text message invitation, the Room Management Module 220 may interface with Short Message Service (SMS) gateways or messaging services via the Network 190 to transmit invitation messages to phone numbers provided by the host user. When the host user selects email invitation, the module may interface with Simple Mail Transfer Protocol (SMTP) servers or email service APIs to transmit invitation messages to email addresses specified by the host user. The transmitted invitations provide recipients with the room identifier necessary to access the game session.

At step 450, a join request is received from another user with the room identifier. This operation is performed by the Room Management Module 220 when users who received invitations attempt to access the game room. In some embodiments, users may enter the room identifier through join interfaces provided by the Communication and User Interface Module 270, and the module may transmit join requests containing the entered room identifier to the Room Management Module 220. The join requests may include user identifiers for the requesting users, enabling the Room Management Module 220 to associate joining users with their authenticated accounts. In some embodiments, users may submit join requests by selecting links included in invitation messages, wherein the links encode the room identifier and automatically populate join interfaces with the correct identifier values.

At step 460, the room identifier is verified and room availability is determined. This operation is performed by the Room Management Module 220, which executes verification processes to confirm that submitted room identifiers correspond to active game rooms. In some embodiments, the Room Management Module 220 may query the Data Repository 290 to locate game room records matching the room identifier submitted in the join request. When a matching record is found, the verification succeeds. When no matching record is found or when the identifier corresponds to a game room that has been closed or expired, the verification fails. In some embodiments, the Room Management Module 220 may determine room availability by evaluating whether the verified game room is accepting new participants. The module may check whether the game room has reached participant capacity limits, whether gameplay has already commenced, or whether the host user has locked the room to prevent additional participants from joining. When the game room is available for new participants, the availability determination succeeds. When the room is full, locked, or gameplay has progressed beyond the joining phase, the availability determination fails.

At step 470, access to the game room is granted or denied based on verification, and room configuration is stored in the data repository. This operation is performed by the Room Management Module 220 based on the verification and availability determination results from step 460. In some embodiments, when both verification and availability determination succeed, the Room Management Module 220 may grant access to the game room by associating the joining user's identifier with the game room record in the Data Repository 290. The module may add the user to the list of participants for the game room, enabling the user to receive game updates, view target word information, submit guesses, and participate in all gameplay activities. The Room Management Module 220 may notify the host user and other participants that a new user has joined the session by transmitting update messages through the Communication and User Interface Module 270.

When verification or availability determination fails, the Room Management Module 220 may deny access by transmitting error messages to the requesting user explaining why access was denied. In some embodiments, error messages may specify that the room identifier is invalid, that the game room is full, that the room has been closed, or that gameplay has already commenced. The denied user remains unable to access the game room or view any information about the game session.

The Room Management Module 220 stores room configuration data in the Data Repository 290 via the Database Engine 280. In some embodiments, the stored configuration includes the generated room identifier, the host user identifier, the selected difficulty level, the configured number of rounds, the list of participating user identifiers, room creation timestamps, and room status indicators that track whether the room is in joining phase, active gameplay phase, or completed phase. This stored configuration persists throughout the game session lifecycle and enables other modules to retrieve game parameters when executing their respective functions. In some embodiments, the Room Management Module 220 may enable the at least one other user to rejoin the game room using the room identifier if network interruptions disconnect the user during gameplay, by verifying that the rejoining user's identifier was previously associated with the game room and granting access without treating the rejoin attempt as a new participant addition.

In some embodiments, the operations of steps 410 through 470 occur when users initiate and join multiplayer game sessions. The automated execution of room creation, identifier generation, invitation coordination, and access verification streamlines multiplayer session organization and eliminates the need for users to coordinate through external platforms. The room identifier serves as both the session isolation mechanism and the access control key, ensuring that only users possessing correct identifiers can participate in designated game sessions.

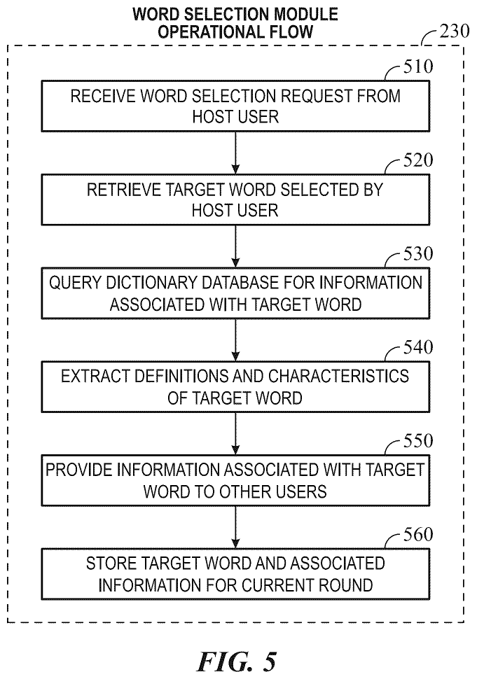

FIG. 5 is a flow diagram illustrating an exemplary operational sequence of the Word Selection Module 230 in accordance with certain embodiments. The sequence shown may be implemented as computer-executable instructions within the application program 200 operating on computing system 100 of FIG. 2, with specific operations performed by the modules depicted therein.

At step 510, a word selection request is received from the host user. This operation may be performed by the Word Selection Module 230 when the host user initiates target word selection for a game round. In some embodiments, the host user may submit word selection requests after other users have joined the game room and gameplay is ready to commence. The Word Selection Module 230 may receive these requests through the Communication and User Interface Module 270, wherein the requests indicate that the host user is prepared to select the target word for the current round. The received request may include the room identifier to associate word selection with the specific game session, enabling the module to maintain separate word selections for concurrent game rooms.

At step 520, the target word selected by the host user is retrieved. This operation is performed by the Word Selection Module 230, which receives the target word input from the host user. In some embodiments, the Word Selection Module 230 may present word selection interfaces that enable the host user to type custom words or select words from suggested vocabulary lists. The module may receive the target word as a text string input and perform validation checks to ensure the input constitutes a valid word for gameplay. In some embodiments, validation may include verifying that the target word contains only alphabetic characters, meets minimum length requirements, or exists in recognized vocabulary databases. When validation succeeds, the module proceeds with the retrieved target word. When validation fails, the module may prompt the host user to select a different word.

At step 530, the dictionary database is queried for information associated with the target word. This operation is performed by the Word Selection Module 230, which constructs and transmits database queries or API requests to the dictionary database or API 295 via the Network 190. In some embodiments, the Word Selection Module 230 may generate Hypertext Transfer Protocol (HTTP) requests formatted according to the API specifications of the dictionary database or API 295, including the target word as a query parameter. The module may include authentication credentials or API keys in the transmitted requests to gain authorized access to dictionary resources. In some embodiments, the Word Selection Module 230 may implement retry logic that re-transmits queries when network errors or timeout conditions prevent successful communication with the dictionary database or API 295, ensuring robust data retrieval even when temporary connectivity issues occur.

At step 540, definitions and characteristics of the target word are extracted. This operation is performed by the Word Selection Module 230, which processes response data returned by the dictionary database or API 295. In some embodiments, the dictionary database or API 295 may return structured data formats such as JavaScript Object Notation (JSON) or Extensible Markup Language (XML) containing word information. The Word Selection Module 230 may parse these structured responses to extract definition text, part-of-speech classifications, usage examples, pronunciation guides, and other linguistic properties. In some embodiments, when the dictionary response includes multiple definitions for polysemous words having multiple meanings, the Word Selection Module 230 may extract all available definitions and count the total number of definitions for use by the Scoring Module 250. The module may also extract the number of letters in the target word by analyzing the length of the word string, providing this characteristic to the Scoring Module 250 for base score calculations.

At step 550, information associated with the target word is provided to other users. This operation is performed by the Word Selection Module 230, which transmits the extracted information to users participating in the game room. In some embodiments, the Word Selection Module 230 may provide the at least one definition of the target word to the at least one other user by transmitting definition text through the Communication and User Interface Module 270 for display on user computing devices 145. The module may format the information for presentation, organizing multiple definitions as numbered or bulleted lists when applicable. In some embodiments, the Word Selection Module 230 may withhold certain information from other users while providing it to the host user, such as showing the actual target word to the host while displaying only definitions to other users attempting to guess the word. The transmission of word information to other users initiates the guessing phase of the game round, enabling users to begin formulating guesses based on the provided definitions.

At step 560, the target word and associated information are stored for the current round. This operation is performed by the Word Selection Module 230 in coordination with the Database Engine 280. In some embodiments, the Word Selection Module 230 may store the target word, extracted definitions, word characteristics, and round identifiers in the Data Repository 290. The stored information remains accessible throughout the current game round for use by other modules. The Hint Generation Module 240 retrieves the stored target word to generate hints based on word letters or characteristics. The Scoring Module 250 retrieves the stored target word to compare against submitted guesses and to access word characteristics for score calculations. In some embodiments, the Word Selection Module 230 may associate the stored word information with timestamps indicating when the round commenced, enabling the system to track round durations or implement time-based gameplay features. The stored data persists until the current round concludes, at which point the Word Selection Module 230 may archive the round data for historical record keeping and initiate word selection processes for subsequent rounds when configured round counts have not been exhausted.

In some embodiments, the operations of steps 510 through 560 occur at the beginning of each game round, whether for the initial round of a game session or for subsequent rounds in multi-round configurations. The automated execution of dictionary queries, information extraction, and data distribution eliminates manual processes for obtaining word definitions and ensures that all participants receive consistent information from authoritative vocabulary sources. The integration with external dictionary database or API 295 enables access to comprehensive linguistic data without requiring local storage of complete dictionary datasets, enabling the game application platform 200 to operate efficiently across resource-constrained devices while maintaining broad vocabulary coverage.

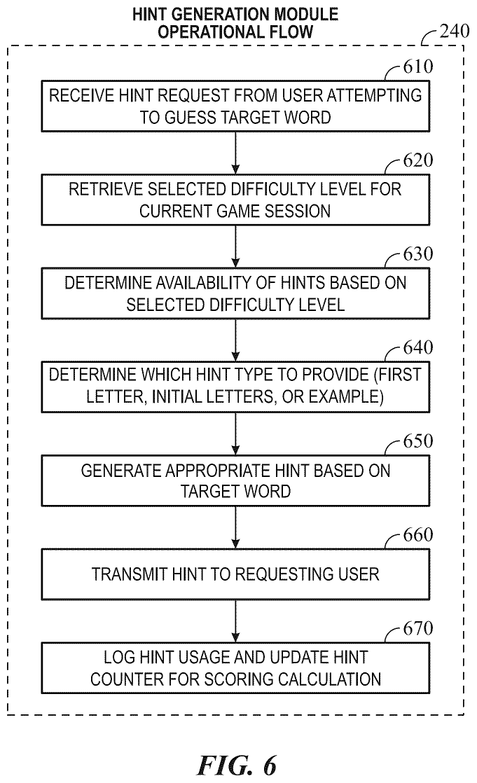

FIG. 6 is a flow diagram illustrating an exemplary operational sequence of the Hint Generation Module 240 in accordance with certain embodiments. The sequence shown may be implemented as computer-executable instructions within the application program 200 operating on computing system 100 of FIG. 2, with specific operations performed by the modules depicted therein.

At step 610, a hint request is received from a user attempting to guess the target word. This operation may be performed by the Hint Generation Module 240 when users participating in game rounds seek assistance in identifying target words. In some embodiments, users may submit hint requests through hint interfaces provided by the Communication and User Interface Module 270 by selecting hint buttons or activating hint request controls. The Hint Generation Module 240 may receive these requests along with user identifiers and room identifiers, enabling the module to associate hint requests with specific users in specific game sessions. The received request signals that the user desires additional information beyond the definitions already provided by the Word Selection Module 230 to assist in formulating an accurate guess.

At step 620, the selected difficulty level for the current game session is retrieved. This operation is performed by the Hint Generation Module 240, which queries the Data Repository 290 via the Database Engine 280 to obtain game configuration data. In some embodiments, the Hint Generation Module 240 may use the room identifier from the hint request to locate the game room record established by the Room Management Module 220, and may extract the selected difficulty level from that record. The retrieved difficulty level indicates whether the game session is configured as beginner level, novice level, or expert level, determining the hint availability rules that will apply to the hint request.

At step 630, availability of hints is determined based on the selected difficulty level. This operation is performed by the Hint Generation Module 240, which applies hint availability rules corresponding to the retrieved difficulty level. In some embodiments, the Hint Generation Module 240 may retrieve current hint usage counts for the requesting user from the Data Repository 290, wherein the usage counts indicate how many hints the user has already utilized during the current game round. The module may compare these current usage counts to maximum hint availability limits defined for the selected difficulty level. When the selected difficulty level comprises the beginner level, the Hint Generation Module 240 may determine that three hints are available, and may compare current usage counts to a limit of three. When the selected difficulty level comprises the novice level, the module may determine that two hints are available, comparing usage counts to a limit of two. When the selected difficulty level comprises the expert level, the module may determine that no hints are available, immediately concluding that hint provision should not proceed.

When current hint usage counts are below the maximum limits for the selected difficulty level, the availability determination succeeds and the process proceeds to generate and provide a hint. When current usage counts have reached or exceeded the limits, the availability determination fails and the Hint Generation Module 240 may deny the hint request by transmitting messages to the requesting user indicating that no additional hints are available for the current difficulty level and round.

At step 640, which hint type to provide is determined. This operation is performed by the Hint Generation Module 240 when availability determination in step 630 confirms that hints remain available. In some embodiments, the Hint Generation Module 240 may determine hint type based on the current hint usage count, providing different hint types in a predetermined sequence. When the hint request represents the user's first hint for the current round, the module may determine that a first hint revealing a first letter of the target word should be provided. When the hint request represents the user's second hint, the module may determine that a second hint revealing a plurality of initial letters of the target word should be provided. When the hint request represents the user's third hint, the module may determine that a third hint providing an example using the target word should be provided. In some embodiments, the Hint Generation Module 240 may evaluate target word characteristics when determining hint types, such as checking whether the target word contains three letters or fewer, and may skip the second hint type in such cases since revealing the first three letters would disclose the entire word.

At step 650, an appropriate hint is generated based on the target word. This operation is performed by the Hint Generation Module 240, which retrieves the target word from the Data Repository 290 and applies generation algorithms corresponding to the hint type determined in step 640. In some embodiments, when generating the first hint, the Hint Generation Module 240 may extract the first letter by accessing the character at the initial position (index zero) of the target word string and formatting this character for display. When generating the second hint, the module may extract a substring comprising the first three characters of the target word using string manipulation functions that return character sequences from specified start positions and lengths. When generating the third hint, the module may retrieve usage examples from the dictionary data previously obtained by the Word Selection Module 230 during step 540 of FIG. 5, selecting examples that demonstrate the target word in context while avoiding examples that make the word too obvious. In some embodiments, when dictionary data does not include pre-existing usage examples, the Hint Generation Module 240 may generate synthetic examples by applying sentence templates that incorporate the target word in grammatically appropriate contexts.

At step 660, the hint is transmitted to the requesting user. This operation is performed by the Hint Generation Module 240 in coordination with the Communication and User Interface Module 270. In some embodiments, the Hint Generation Module 240 may format the generated hint for presentation, adding labels or context information that explains what type of hint is being provided, such as indicating “First Letter:” followed by the extracted character, or “First Three Letters:” followed by the extracted substring. The module may transmit the formatted hint through the Communication and User Interface Module 270 to the user computing device 145 associated with the requesting user, enabling display of the hint in game interfaces. In some embodiments, the Hint Generation Module 240 may selectively transmit hints only to the requesting user rather than broadcasting hints to all participants in the game room, ensuring that users who have not requested hints do not receive assistance they did not seek and maintaining independent difficulty experiences for different users when game configurations permit individual hint usage.

At step 670, hint usage is logged and the hint counter is updated for scoring calculation. This operation is performed by the Hint Generation Module 240 in coordination with the Database Engine 280. In some embodiments, the Hint Generation Module 240 may increment the hint usage counter for the requesting user by retrieving the current count from the Data Repository 290, adding one to the retrieved value, and storing the incremented count back to the repository. The module may also generate hint usage log entries that record which user requested the hint, what type of hint was provided, when the hint was provided, and which game round and room the hint pertains to. These log entries create audit trails of hint usage throughout gameplay.

The updated hint usage counter becomes available to the Scoring Module 250 when users submit guesses and scores are calculated. In some embodiments, the Hint Generation Module 240 may transmit hint usage notifications to the Scoring Module 250 immediately upon incrementing counters, enabling the Scoring Module 250 to maintain real-time awareness of hint usage without requiring repeated database queries. The logged hint usage and updated counters ensure that the multi-factor scoring algorithms implemented by the Scoring Module 250 can accurately assess penalty deductions based on how many hints each user utilized during gameplay.

In some embodiments, the operations of steps 610 through 670 occur each time users request hints during game rounds, potentially multiple times per user per round depending on difficulty level configurations. The automated execution of difficulty-based availability determination, sequential hint type provision, and usage tracking implements structured assistance mechanisms that scale challenge appropriately while maintaining accurate records for scoring purposes.

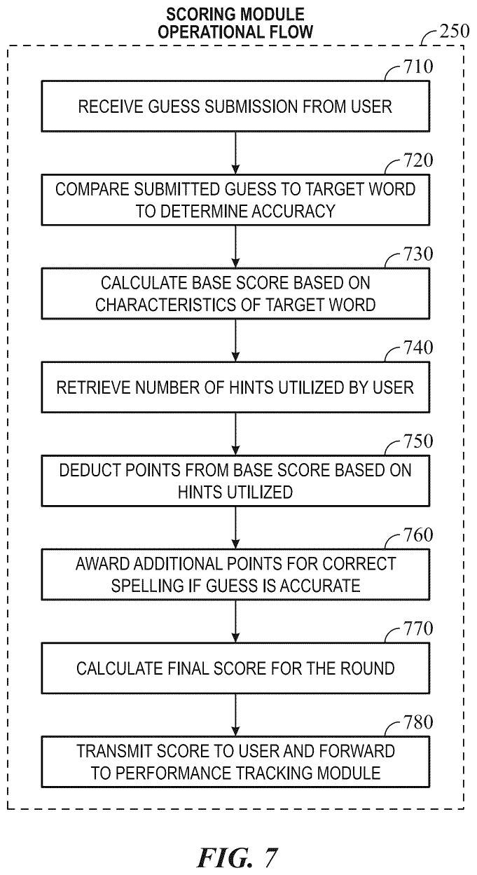

FIG. 7 is a flow diagram illustrating an exemplary operational sequence of the Scoring Module 250 in accordance with certain embodiments. The sequence shown may be implemented as computer-executable instructions within the application program 200 operating on computing system 100 of FIG. 2, with specific operations performed by the modules depicted therein.

At step 710, a guess submission is received from a user. This operation may be performed by the Scoring Module 250 when users participating in game rounds attempt to identify target words. In some embodiments, users may submit guesses through input interfaces provided by the Communication and User Interface Module 270 by typing word guesses into text input fields and activating submission controls. The Scoring Module 250 may receive these submissions along with user identifiers, room identifiers, and round identifiers, enabling the module to associate guesses with specific users in specific game rounds. The received submission may undergo preprocessing to normalize capitalization, remove extraneous whitespace, or correct obvious typographical variations before comparison processing occurs.

At step 720, the submitted guess is compared to the target word to determine accuracy. This operation is performed by the Scoring Module 250, which retrieves the target word from the Data Repository 290 and executes comparison algorithms. In some embodiments, the Scoring Module 250 may perform exact string matching by comparing the submitted guess character-by-character to the target word, determining that the guess is accurate when all characters match in sequence and length. The comparison may be case-insensitive, converting both the guess and target word to lowercase or uppercase before comparison to avoid penalizing users for capitalization differences. In some embodiments, the Scoring Module 250 may implement fuzzy matching algorithms that tolerate minor spelling variations, calculating string similarity scores using techniques such as Levenshtein distance or Jaro-Winkler distance, and determining accuracy when similarity exceeds predetermined thresholds. The comparison determines whether the user successfully identified the target word, which affects subsequent scoring calculations and bonus point awards.

At step 730, a base score is calculated based on characteristics of the target word. This operation is performed by the Scoring Module 250, which retrieves target word characteristics from the Data Repository 290 or from data provided by the Word Selection Module 230. In some embodiments, the characteristic of the target word may comprise a number of letters in the target word, and the Scoring Module 250 may calculate the base score by counting characters in the target word string. The module may assign point values equal to the letter count, such that a five-letter word generates a base score of five points while an eight-letter word generates a base score of eight points. In some embodiments, when the information associated with the target word comprises a plurality of definitions, the Scoring Module 250 may base the score on a number of definitions by retrieving definition count data and adding the definition count to the letter-based score component. The integration of letter count and definition count into the base score reflects both word length complexity and semantic complexity in the scoring calculation.

At step 740, the number of hints utilized by the user is retrieved. This operation is performed by the Scoring Module 250, which queries the Data Repository 290 via the Database Engine 280 to obtain hint usage data. In some embodiments, the Scoring Module 250 may retrieve the hint usage counter for the specific user and round from storage locations where the Hint Generation Module 240 maintained usage records during step 670 of FIG. 6. The retrieved hint usage count indicates how many hints the user requested during the current round, providing the data necessary to calculate penalty deductions.

At step 750, points are deducted from the base score based on hints utilized. This operation is performed by the Scoring Module 250, which applies penalty calculations to the base score calculated in step 730. In some embodiments, the Scoring Module 250 may deduct a first point value when a first hint was utilized, deduct a second point value when a second hint was utilized, and deduct a third point value when a third hint was utilized, wherein the second point value is greater than the first point value and the third point value is greater than the second point value. The module may implement progressive penalty structures by deducting one point for first hint usage, two points for second hint usage, and three points for third hint usage. In some embodiments, penalty values may be cumulative, such that a user who utilized two hints would have three total points deducted (one point for the first hint plus two points for the second hint). The Scoring Module 250 may subtract the calculated penalty from the base score to produce an adjusted score reflecting hint usage impact.

At step 760, additional points are awarded for correct spelling if the guess is accurate. This operation is performed by the Scoring Module 250 based on the accuracy determination from step 720. In some embodiments, when the comparison in step 720 determined that the submitted guess matches the target word, the Scoring Module 250 may award bonus points for spelling accuracy. The module may add a predetermined bonus value to the adjusted score from step 750, such as adding five points for correct spelling. This spelling bonus rewards users for accurate word identification and partially offsets penalty deductions from hint usage. When the comparison in step 720 determined that the guess was inaccurate, the Scoring Module 250 may skip this bonus award and may assign a score of zero for the round regardless of the base score and hint usage calculations.

At step 770, the final score for the round is calculated. This operation is performed by the Scoring Module 250, which integrates all scoring components computed in previous steps. In some embodiments, the Scoring Module 250 may calculate the final score by starting with the base score from step 730, subtracting hint usage penalties from step 750, and adding spelling accuracy bonuses from step 760 when applicable. The module may apply minimum score thresholds ensuring that final scores do not become negative values even when penalties exceed base scores. In some embodiments, the Scoring Module 250 may apply scoring multipliers or modifiers based on round completion speed or other performance factors, enabling additional scoring complexity beyond the fundamental components of word characteristics, hint usage, and spelling accuracy.

At step 780, the score is transmitted to the user and forwarded to the performance tracking module. This operation is performed by the Scoring Module 250 in coordination with the Communication and User Interface Module 270 and the Performance Tracking Module 260. In some embodiments, the Scoring Module 250 may transmit the calculated final score to the user computing device 145 via the Communication and User Interface Module 270, enabling display of score results in game interfaces. The module may format score presentations to show scoring component breakdowns, displaying how base scores were calculated, how many points were deducted for hints, and whether spelling bonuses were awarded. The Scoring Module 250 may simultaneously forward score data to the Performance Tracking Module 260 for accumulation in long-term performance records, enabling the Performance Tracking Module 260 to update cumulative point totals and performance statistics for the user's account. In some embodiments, the Scoring Module 250 may also transmit score data to the Room Management Module 220 to determine whether additional rounds remain in the game session or whether configured round counts have been completed, enabling automated progression to subsequent rounds or session termination.

In some embodiments, the operations of steps 710 through 780 occur each time users submit guesses during game rounds, whether guesses are accurate or inaccurate. The automated execution of guess evaluation, multi-factor score calculation, and score distribution implements comprehensive performance assessment mechanisms that account for word complexity, assistance usage, and answer accuracy while providing immediate feedback to users and maintaining persistent performance records.

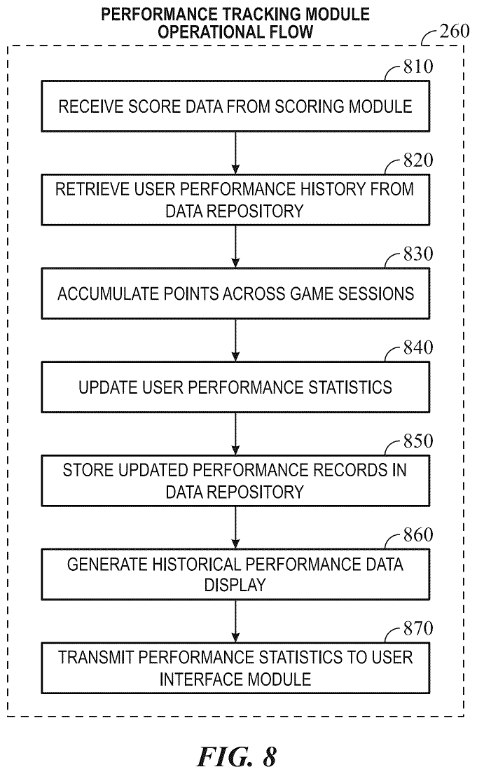

FIG. 8 is a flow diagram illustrating an exemplary operational sequence of the Performance Tracking Module 260 in accordance with certain embodiments. The sequence shown may be implemented as computer-executable instructions within the application program 200 operating on computing system 100 of FIG. 2, with specific operations performed by the modules depicted therein.

At step 810, score data is received from the scoring module. This operation may be performed by the Performance Tracking Module 260 when the Scoring Module 250 completes score calculations during step 780 of FIG. 7. In some embodiments, the Performance Tracking Module 260 may receive score data transmissions containing calculated final scores, user identifiers, room identifiers, round identifiers, word characteristics that influenced scoring, hint usage counts, and timestamps indicating when scores were calculated. The received score data provides the raw performance information that will be integrated into long-term user performance records maintained by the Performance Tracking Module 260.

At step 820, user performance history is retrieved from the data repository. This operation is performed by the Performance Tracking Module 260, which queries the Data Repository 290 via the Database Engine 280 to obtain existing performance records. In some embodiments, the Performance Tracking Module 260 may use the user identifier from the received score data to locate the user's performance history records in the Data Repository 290. The module may retrieve cumulative point totals accumulated from previous game sessions, counts of total games played, historical score sequences from past rounds, average score statistics, difficulty level usage patterns, and timestamps of previous gameplay activities. This retrieved historical data provides the baseline against which new score data will be integrated.

At step 830, points are accumulated across game sessions. This operation is performed by the Performance Tracking Module 260, which applies accumulation algorithms to integrate new score data with historical totals. In some embodiments, the Performance Tracking Module 260 may maintain a record of user performance across a plurality of game sessions by storing cumulative point values that span multiple distinct gameplay sessions over extended time periods. The module may add the final score received in step 810 to the cumulative point total retrieved in step 820, generating an updated cumulative total that reflects all scoring achievements to date. In some embodiments, the accumulation may involve maintaining separate point totals for different difficulty levels, enabling the module to track how many points users have accumulated at beginner level, novice level, and expert level independently. The module may also accumulate round counts, incrementing counters that track total rounds played, rounds won with accurate guesses, and rounds completed without hint usage.

At step 840, user performance statistics are updated. This operation is performed by the Performance Tracking Module 260, which calculates derived metrics based on accumulated performance data. In some embodiments, the module may calculate average score per session by dividing cumulative point totals by total game session counts. The Performance Tracking Module 260 may identify highest score achieved by comparing the newly received score to previously recorded maximum scores and updating the maximum value when the new score exceeds previous records. The module may calculate average hint usage rates by dividing total hints used across all rounds by total rounds played, providing metrics on how frequently users seek assistance. In some embodiments, the Performance Tracking Module 260 may analyze historical performance data to identify trends, such as calculating moving averages that show whether user performance is improving over recent sessions, or identifying difficulty level progression patterns that indicate when users may be ready to advance to higher difficulty settings. The module may also track achievement milestones, updating flags or counters when users reach significant point thresholds or complete notable gameplay objectives.

At step 850, updated performance records are stored in the data repository. This operation is performed by the Performance Tracking Module 260 in coordination with the Database Engine 280. In some embodiments, the Performance Tracking Module 260 may store the updated cumulative point totals, incremented game and round counts, recalculated statistics, and new achievement flags in the Data Repository 290. The module may transmit database update commands to the Database Engine 280 specifying which performance record fields require modification and what new values should be stored. In some embodiments, the Performance Tracking Module 260 may append new score entries to historical score sequences while maintaining existing historical records, enabling preservation of complete gameplay history rather than only retaining summary statistics. The stored performance records persist indefinitely or until users request data deletion, enabling long-term performance tracking across extended periods of platform usage.

At step 860, historical performance data display is generated. This operation is performed by the Performance Tracking Module 260, which formats performance information for presentation to users. In some embodiments, the module may display historical performance data to at least one of the plurality of users by generating data visualizations, summary tables, or graphical representations of performance trends. The Performance Tracking Module 260 may create displays showing cumulative point totals prominently, accompanied by supporting metrics such as total games played, average scores, highest scores, and recent performance trends. The module may generate charts or graphs visualizing score progression over time, enabling users to see performance improvement patterns across multiple sessions. In some embodiments, the Performance Tracking Module 260 may implement leaderboard functionality that compares user performance statistics against other users' statistics, ranking users by cumulative points or other performance metrics. The generated displays may include achievement badges or progress indicators that recognize when users reach point milestones or complete challenging objectives.

At step 870, performance statistics are transmitted to the user interface module. This operation is performed by the Performance Tracking Module 260 in coordination with the Communication and User Interface Module 270. In some embodiments, the Performance Tracking Module 260 may transmit the formatted performance displays generated in step 860 to the Communication and User Interface Module 270, which then delivers these displays to user computing devices 145 via the Network 190. The transmitted performance statistics may appear in dedicated performance history interfaces that users can access through menu selections, or may be displayed automatically after game rounds conclude to provide immediate performance feedback. In some embodiments, the Performance Tracking Module 260 may transmit performance summary notifications periodically, such as weekly or monthly performance reports delivered to user devices, highlighting recent achievements, point accumulation rates, and performance trend observations. The transmission of performance statistics completes the performance tracking cycle initiated when score data was received in step 810, ensuring that users have visibility into their long-term gameplay progress and accumulated achievements.

In some embodiments, the operations of steps 810 through 870 occur after each scored game round, continuously updating performance records as users participate in gameplay. The automated execution of score accumulation, statistics calculation, and performance display generation maintains persistent user engagement tracking that spans multiple game sessions and enables users to monitor skill progression over time. The long-term performance records maintained by the Performance Tracking Module 260 provide continuity across game sessions that would not exist in systems that reset performance data when sessions end.

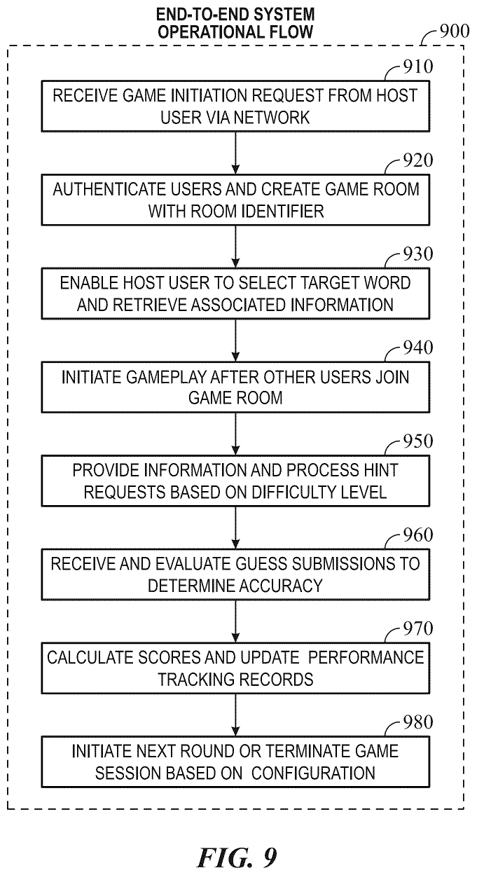

FIG. 9 is a flow diagram illustrating an exemplary end-to-end system 900 operational flow in accordance with certain embodiments. The sequence shown may be implemented as computer-executable instructions within the application program 200 operating on computing system 100 of FIG. 2, demonstrating the integrated operation of multiple modules to process game sessions from initial request through final termination.

At step 910, a game initiation request is received from a host user via the network. This operation may be performed by the Communication and User Interface Module 270, which receives game initiation requests from user computing devices 145 via the Network 190. In some embodiments, host users may access the game application platform 200 through web browsers or mobile applications and select options to create new game sessions. The Communication and User Interface Module 270 may receive the initiation requests and forward them to the User Account Module 210 and Room Management Module 220 for processing. The received initiation request signals the beginning of the complete gameplay workflow, triggering coordinated operations across multiple modules to establish and execute the game session.

At step 920, users are authenticated and a game room is created with a room identifier. This operation is performed through coordination between the User Account Module 210 and the Room Management Module 220. In some embodiments, the User Account Module 210 may execute the authentication sequence described in steps 310 through 370 of FIG. 3, authenticating a plurality of users including the host user who initiated the request and any other users who will join the session. Following successful authentication, the Room Management Module 220 may execute the room creation sequence described in steps 410 through 430 of FIG. 4, generating a room identifier for a game room and enabling the host user to configure game parameters including the selected difficulty level and the number of rounds to be played in the game room. The combination of user authentication and room creation establishes the foundational session structure necessary for gameplay.

At step 930, the host user is enabled to select a target word and associated information is retrieved. This operation is performed by the Word Selection Module 230, which executes the word selection sequence described in steps 510 through 560 of FIG. 5. In some embodiments, the Word Selection Module 230 may enable the host user to select a target word, query the dictionary database or API 295 via the Network 190 for information associated with the selected target word, extract definitions and characteristics from query responses, and store the target word and associated information for the current round. This word selection operation prepares the target word data that will be provided to other users and used by subsequent modules during gameplay.

At step 940, gameplay is initiated after other users join the game room. This operation is performed by the Room Management Module 220 in coordination with the Communication and User Interface Module 270. In some embodiments, the Room Management Module 220 may execute the invitation and join sequences described in steps 440 through 470 of FIG. 4, enabling the host user to invite at least one other user via text message or email, receiving join requests containing the room identifier, verifying submitted room identifiers, and granting access when verification succeeds. The game application platform 200 may monitor participant counts and room status to determine when sufficient users have joined to commence gameplay. When joining is complete, the Room Management Module 220 may transition the game room from joining phase to active gameplay phase, signaling to other modules that gameplay operations should begin. The Communication and User Interface Module 270 may notify all participants that gameplay is starting, displaying game interfaces that show target word information and input controls for guess submission and hint requests.

At step 950, information is provided and hint requests are processed based on difficulty level. This operation involves coordination between the Word Selection Module 230 and the Hint Generation Module 240. In some embodiments, the Word Selection Module 230 may provide information associated with the target word to the at least one other user by transmitting extracted definitions through the Communication and User Interface Module 270, as described in step 550 of FIG. 5. Users viewing the provided definitions may request hints through hint interfaces, and the Hint Generation Module 240 may execute the hint generation sequence described in steps 610 through 670 of FIG. 6, retrieving the selected difficulty level, determining availability of at least one hint based on the difficulty level, generating appropriate hints, transmitting hints to requesting users, and logging hint usage for scoring purposes. The provision of definitions and hints supplies users with the information needed to formulate guesses about the target word.

At step 960, guess submissions are received and evaluated to determine accuracy. This operation is performed by the Scoring Module 250, which executes portions of the scoring sequence described in steps 710 through 720 of FIG. 7. In some embodiments, the Scoring Module 250 may receive guess submissions from users via the Communication and User Interface Module 270, and may compare submitted guesses to the target word to determine accuracy of the guesses. When a user submits an accurate guess that matches the target word, the evaluation determines that the round is complete for that user. When submitted guesses are inaccurate, users may continue requesting additional hints and submitting additional guess attempts until either accurately guessing the word or exhausting available gameplay time or attempt limits.

At step 970, scores are calculated and performance tracking records are updated. This operation involves coordination between the Scoring Module 250 and the Performance Tracking Module 260. In some embodiments, the Scoring Module 250 may execute the complete scoring sequence described in steps 730 through 780 of FIG. 7, calculating a score based on at least one of a characteristic of the target word, a number of hints utilized by the user, or accuracy of the guess submitted by the user. The module calculates base scores from word characteristics, deducts points based on hint usage, awards spelling bonuses for accurate guesses, calculates final scores integrating all components, and transmits calculated scores to users and forwards them to the Performance Tracking Module 260. The Performance Tracking Module 260 may then execute the performance tracking sequence described in steps 810 through 870 of FIG. 8, receiving score data, retrieving user performance history, accumulating points across game sessions, updating statistics, storing updated records, generating performance displays, and transmitting statistics to the Communication and User Interface Module 270.

At step 980, the next round is initiated or the game session is terminated based on configuration. This operation is performed by the Room Management Module 220 in coordination with other modules. In some embodiments, the Room Management Module 220 may retrieve the configured number of rounds from the game room record and compare the current round count to the configured total. When additional rounds remain to be played, the module may initiate the next round by signaling to the Word Selection Module 230 to begin another word selection sequence, enabling the host user to select a new target word and commencing another iteration of the gameplay cycle described in steps 930 through 970. When all configured rounds have been completed, the Room Management Module 220 may terminate the game session by closing the game room, archiving session data to the Data Repository 290, and notifying all participants that the session has concluded. The Communication and User Interface Module 270 may display final session summaries showing cumulative scores across all rounds, performance achievements, and options to create new game sessions or return to main menu interfaces.

In some embodiments, the operations of steps 910 through 980 represent the complete end-to-end workflow for processing game sessions in the game application platform 200. The integrated operation of multiple modules enables the system to receive game requests, authenticate users, establish isolated game sessions through room-based architecture, coordinate word selection and information provision, process hint requests based on difficulty configurations, evaluate guess submissions, calculate comprehensive scores accounting for multiple factors, maintain persistent performance records, and manage multi-round session progression. This coordinated workflow automates gameplay session management that would traditionally require manual coordination through external platforms, provides structured difficulty progression through integrated hint systems, implements multi-factor scoring mechanisms that account for word complexity and player performance, and maintains long-term performance tracking that enables skill monitoring across extended platform usage periods. The end-to-end integration of authentication, room management, word selection, hint generation, scoring, and performance tracking modules transforms isolated gaming functions into a cohesive multiplayer word guessing platform that facilitates efficient gameplay coordination with comprehensive performance assessment.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which enables a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which enable a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API enables programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented word guessing game system for facilitating multiplayer gameplay, the system comprising:
at least one computing device in operable communication with a network;
a server in operable communication with the at least one computing device over the network, the server configured to host a game application platform comprising:
a user account module configured to authenticate a plurality of users;
a room management module configured to:
generate a room identifier for a game room;
enable a host user to invite at least one other user to join the game room; and
control access to the game room based on the room identifier;
a word selection module configured to enable the host user to select a target word and to provide information associated with the target word to the at least one other user;
a hint generation module configured to provide at least one hint to assist the at least one other user in guessing the target word, wherein availability of the at least one hint is determined based on a selected difficulty level;
a scoring module configured to calculate a score based on at least one of a characteristic of the target word, a number of hints utilized by a user, or accuracy of a guess submitted by the user; and
a performance tracking module configured to maintain a record of user performance across a plurality of game sessions.

2. The system of claim 1, wherein the information associated with the target word comprises at least one definition of the target word retrieved from a dictionary database, and wherein the scoring module is configured to base the score on a number of definitions when a plurality of definitions is provided.

3. The system of claim 1, wherein the at least one hint comprises a first hint revealing a first letter of the target word, a second hint revealing a plurality of initial letters of the target word, and a third hint providing an example using the target word.

4. The system of claim 1, wherein the selected difficulty level comprises at least one of a beginner level providing three hints, a novice level providing two hints, or an expert level providing no hints.

5. The system of claim 1, wherein the characteristic of the target word comprises a number of letters in the target word, and wherein the scoring module is further configured to award points for correct spelling of the target word.

6. The system of claim 1, wherein the scoring module is configured to deduct a first point value when a first hint is utilized, deduct a second point value when a second hint is utilized, and deduct a third point value when a third hint is utilized, wherein the second point value is greater than the first point value and the third point value is greater than the second point value.

7. The system of claim 1, wherein the room management module is further configured to enable the host user to invite the at least one other user via at least one of text message or email.

8. The system of claim 1, wherein the user account module is configured to authenticate the plurality of users via at least one of manual entry or social media integration.

9. The system of claim 1, wherein the room management module is further configured to enable the at least one other user to join the game room by entering the room identifier, determine room availability before enabling access to the game room, and enable the at least one other user to rejoin the game room using the room identifier.

10. The system of claim 1, wherein the room management module is further configured to enable the host user to select a number of rounds to be played in the game room.

11. The system of claim 1, wherein the game application platform further comprises a user interface module configured to enable the at least one other user to submit a guess for the target word, and wherein the scoring module is configured to evaluate the guess to determine the accuracy.

12. The system of claim 1, wherein the game application platform is configured to initiate gameplay after the at least one other user has joined the game room.

13. The system of claim 1, wherein the game application platform further comprises a settings module configured to enable at least one of the plurality of users to configure game parameters prior to initiating gameplay.

14. The system of claim 1, wherein the performance tracking module is further configured to accumulate points across the plurality of game sessions and display historical performance data to at least one of the plurality of users.

15. A computer-implemented method, executed by at least one processor of a computing device, for facilitating multiplayer word guessing gameplay, the method comprising:
authenticating, via the computing device, a plurality of users;
generating, via the computing device, a room identifier for a game room;
enabling, via the computing device, a host user to invite at least one other user to join the game room;
controlling, via the computing device, access to the game room based on the room identifier;
enabling, via the computing device, the host user to select a target word;
providing, via the computing device, information associated with the target word to the at least one other user;
providing, via the computing device, at least one hint to assist the at least one other user in guessing the target word, wherein availability of the at least one hint is determined based on a selected difficulty level;
calculating, via the computing device, a score based on at least one of: a characteristic of the target word, a number of hints utilized by a user, or accuracy of a guess submitted by the user; and
maintaining, via the computing device, a record of user performance across a plurality of game sessions.

16. The method of claim 15, wherein providing the information associated with the target word comprises providing at least one definition of the target word, and wherein calculating the score comprises basing the score on a number of definitions when a plurality of definitions is provided.

17. The method of claim 15, wherein providing the at least one hint comprises providing a first hint revealing a first letter of the target word, providing a second hint revealing a plurality of initial letters of the target word, and providing a third hint comprising an example using the target word, and wherein calculating the score comprises deducting points based on which hints are utilized.

18. The method of claim 15, further comprising initiating, via the computing device, gameplay after the at least one other user has joined the game room, and enabling, via the computing device, the host user to select a number of rounds to be played in the game room.

19. A software product comprising at least one computer-readable storage medium having application instructions stored on the at least one computer-readable storage medium, the application instructions executable by at least one processor to:
authenticate a plurality of users;
generate a room identifier for a game room;
enable a host user to invite at least one other user to join the game room;
control access to the game room based on the room identifier;
enable the host user to select a target word;
provide information associated with the target word to the at least one other user;
provide at least one hint to assist the at least one other user in guessing the target word, wherein availability of the at least one hint is determined based on a selected difficulty level;
calculate a score based on at least one of: a characteristic of the target word, a number of hints utilized by a user, or accuracy of a guess submitted by the user; and
maintain a record of user performance across a plurality of game sessions.

20. The software product of claim 19, wherein the application instructions are further executable by the at least one processor to provide a first hint revealing a first letter of the target word, provide a second hint revealing a plurality of initial letters of the target word, provide a third hint comprising an example using the target word, and deduct points from the score based on a number of hints utilized, wherein a first point value is deducted for utilizing a first hint, a second point value is deducted for utilizing a second hint, and a third point value is deducted for utilizing a third hint.
